(19) United States
(12) Patent Application Publication
(10) Pub. No.: US 2009/0119487 A1
(43) Pub. Date: May 7, 2009

(54) ARITHMETIC PROCESSING APPARATUS FOR EXECUTING INSTRUCTION CODE FETCHED FROM INSTRUCTION CACHE MEMORY

(76) Inventor: Soichiro HOSODA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/260,269

(22) Filed: Oct. 29, 2008

(30) Foreign Application Priority Data
Nov. 6, 2007 (JP) 2007-288965

(51) Int. Cl. G06F 9/312

(52) U.S. Cl. 712/205; 712/E09.033

(57) ABSTRACT

An arithmetic processing apparatus includes a cache block which stores a plurality of instruction codes from a main memory, a central processing unit which fetch-accesses the cache block and sequentially loads and executes the plurality of instruction codes, and a repeat buffer which stores an instruction code group corresponding to a buffer size, the instruction code group ranging from a head instruction code to a terminal instruction code among the head instruction code to an end instruction code of a repeat block repeatedly executed in the processing program, in the plurality of instruction codes stored in the cache block. The arithmetic processing apparatus further includes an instruction cache control unit which performs control so that the instruction code group stored in the repeat buffer is selected and supplied to the central processing unit when the repeat block is repeatedly executed.

### CROSS-REFERENCE TO RELATED APPLICATIONS

This application is based upon and claims the benefit of priority from prior Japanese Patent Application No. 2007-288965, filed Nov. 6, 2007, the entire contents of which are incorporated herein by reference.

### BACKGROUND OF THE INVENTION

1. Field of the Invention

The present invention relates to an arithmetic processing apparatus. More particularly, it relates to a microprocessor for executing an instruction code including a repeat block (repeatedly executed instruction code group) fetched from an instruction cache memory.

2. Description of the Related Art

A microprocessor for executing an instruction code fetched from an instruction cache memory may execute a repeat block in a program. In executing the repeat block, although the same instruction code group is repeatedly executed, it has hitherto been the case that the instruction cache memory is accessed every time to fetch an instruction code group to be executed. Therefore, the problem is that power is consumed every time the instruction cache memory is accessed.

Thus, there has been proposed a system wherein a buffer is provided to sequentially store therein information on an instruction output from an instruction cache memory, and when the entry of the instruction into an instruction loop is detected, the instruction in the instruction loop is output from the buffer (see, for example, Jpn. Pat. Appln. KOKAI Publication No. 09-71136).

However, a scheme as in this proposal has several problems as follows: For example, when the instruction code of the repeat block is stored in the buffer in response to the issuance of a repeat instruction, a control circuit is newly required to control the buffer in accordance with a decoding result of an instruction decoder so that the buffer starts the storage of the instruction code. An address comparator is also needed to output, from the buffer, an instruction code to be fetched which has been determined to correspond to an instruction code in the repeat block in the buffer. Moreover, every time an instruction code is fetched, an address comparison has to be made between the fetched instruction code and the instruction code stored in the buffer, which leads to extra power consumption.

Particularly in the case where the instruction cache memory is a set associative instruction cache, it is impossible to determine a way (cache data random access memory [RAM]) in which an instruction code following the instruction code in the buffer is present if the boundary of the buffer is not coincident with the line boundary of the instruction cache memory. Therefore, after the instruction codes in the buffer have been used up, all the ways are accessed, leading to extra power consumption.

As described above, in the conventional scheme which supplies the instruction code from the buffer to reduce the number of accesses to the instruction cache memory in executing the repeat block in the program, it is possible to hold down the power consumption associated with the access to the instruction cache memory. However, there has been a problem of the extra power consumption in that the control circuit is needed to cause the buffer to start the storage of the instruction code as well as the address comparator for the address comparison between the fetched instruction code and the instruction code stored in the buffer and in that the all the ways have to be accessed to read the instruction code following the instruction code in the buffer.

### BRIEF SUMMARY OF THE INVENTION

According to a first aspect of the present invention, there is provided an arithmetic processing apparatus comprising: a cache block which stores at least some of a plurality of instruction codes in a processing program stored in a main memory; a central processing unit which fetch-accesses the cache block and sequentially loads and executes the at least some of a plurality of instruction codes; a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block; and an instruction cache control unit which performs control so that the instruction code group stored in the repeat buffer is selected and supplied to the central processing unit when the repeat block is repeatedly executed.

According to a second aspect of the present invention, there is provided an arithmetic processing apparatus comprising: a cache block which stores at least some of a plurality of instruction codes in a processing program stored in a main memory; a central processing unit which fetch-accesses the cache block and sequentially loads and executes the at least some of a plurality of instruction codes; a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block; an instruction cache control unit which performs control so that the instruction code group stored in the repeat buffer is selected and supplied to the central processing unit when the repeat block is repeatedly executed; a tag RAM which stores tag information corresponding to a line of the cache block; and a storage which previously reads tag information corresponding to the next line from the tag RAM at the time of a fetch access before the crossing of the boundary of the line of the cache block in order to generate an address expected to be accessed by a sequential fetch request crossing the boundary of the next line, thereby retaining the result of a comparison between the address and the tag information, wherein when actually accessing the cache block in response to the sequential fetch request crossing the line boundary from the central processing unit, the instruction cache control unit controls the access to the cache block on the basis of the comparison result retained in the storage.

According to a third aspect of the present invention, there is provided an arithmetic processing apparatus comprising: a cache block which stores at least some of a plurality of instruction codes in a processing program stored in a main memory; a central processing unit which fetch-accesses the cache block and sequentially loads and executes the at least some of a plurality of instruction codes; a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block; and an instruction cache control unit which performs control so that the instruction code group stored in the repeat buffer is selected and supplied to the central processing unit when the repeat block is repeatedly executed, wherein the repeat buffer is configured by a multifunction buffer also functioning as a pre-fetch buffer of the cache block which stores the plurality of instruction codes stored in the main memory, and the use of the multifunction buffer is switched and controlled in accordance with a fetch request from the central processing unit so that the multifunction buffer functions as the pre-fetch buffer when there is no repeat block to be repeatedly executed in the processing program.

### BRIEF DESCRIPTION OF THE SEVERAL VIEWS OF THE DRAWING

FIG. 1 is a block diagram showing an example of the configuration of an arithmetic processing apparatus (microprocessor) according to a first embodiment of the present invention;

FIG. 2 is a diagram shown to explain an example of the operations of a repeat buffer and a way indicator in the microprocessor;

FIG. 3 is a diagram shown to explain another example of the operations of the repeat buffer and the way indicator in the microprocessor;

FIG. 4 is a block diagram showing an example of the configuration of an arithmetic processing apparatus (microprocessor) according to a second embodiment of the present invention; and

FIG. 5 is a block diagram showing an example of the configuration of an arithmetic processing apparatus (microprocessor) according to a third embodiment of the present invention.

### DETAILED DESCRIPTION OF THE INVENTION

Embodiments of the present invention will be described with reference to the accompanying drawings. It should be noted that the drawings are schematic ones and the dimension ratios shown therein are different from the actual ones. The dimensions vary from drawing to drawing and so do the ratios of dimensions. The following embodiments are directed to a device and a method for embodying the technical concept of the present invention and the technical concept does not specify the material, shape, structure or configuration of components of the present invention. Various changes and modifications can be made to the technical concept without departing from the scope of the claimed invention.

### First Embodiment

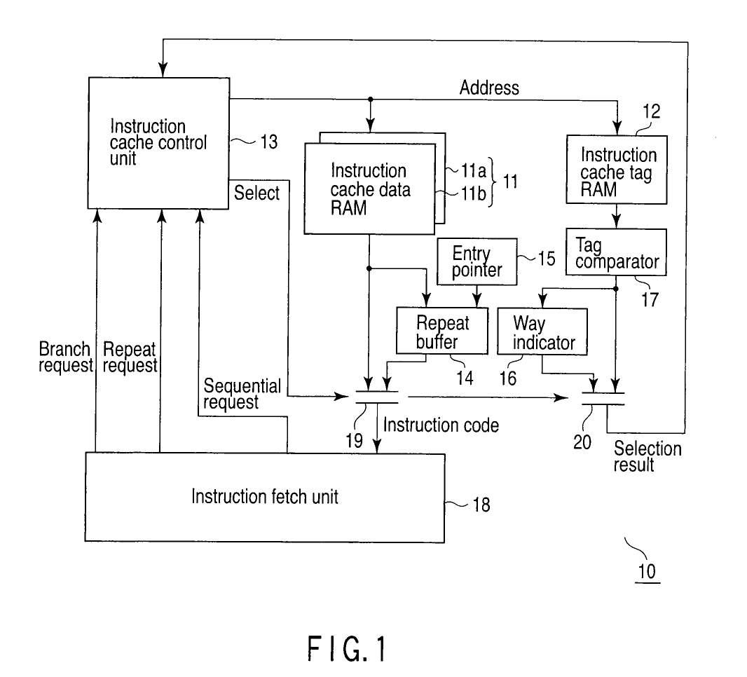

FIG. 1 shows an example of the configuration of an arithmetic processing apparatus (microprocessor) according to a first embodiment of the present invention. In the present embodiment, an instruction cache system is explained as an example which comprises a repeat buffer for storing an instruction code from an instruction cache memory as a cache block.

As shown in FIG. 1, an instruction cache system 10 comprises an instruction cache data RAM 11, an instruction cache tag RAM 12, an instruction cache control unit 13, a repeat buffer 14, an entry pointer 15, a way indicator 16, a tag comparator 17, an in-processor instruction fetch unit (central processing unit) 18, and selection circuits 19, 20.

The instruction cache data RAM 11 has, for example, two associative instruction cache data RAMs (way-0, way-1) 11a, 11b. These instruction cache data RAMs 11a, 11b store some of the instruction codes in a program stored in an unshown external main memory (main storage). In addition, the present embodiment shows a case where the number of ways of the instruction cache data RAM 11 is “2” (way-0, way-1). The number of ways of the instruction cache data RAM 11 can be freely increased to n×ways.

The instruction fetch unit 18 fetch-accesses the instruction cache data RAM 11 via the instruction cache control unit 13, and selectively loads and executes an instruction code from the instruction cache data RAM 11 (or an instruction code from the repeat buffer 14). Moreover, when a repeat instruction which defines a repeat block as an instruction code group in the program to be repeatedly executed is issued, this instruction fetch unit 18 stores a program counter value of a head word (repeat begin) of the repeat block, and a program counter value of a terminal word (repeat end).

The repeat buffer 14 stores at least some of the instruction codes of the repeat block stored in the instruction cache data RAM 11 in accordance with its size (capacity). That is, the repeat buffer 14 stores the instruction codes corresponding to an entry (buffer size) starting from the head word of the instruction code group independently of the line sizes of the instruction cache data RAMs 11a, 11b.

The entry pointer 15 stores the entry to be processed among the entries in the repeat buffer 14, and its value is incremented every sequential request.

The way indicator 16 manages way information (flag) for the instruction cache data RAM which stores the instruction code of the repeat block following the instruction code stored in each entry of the repeat buffer 14.

The instruction cache control unit 13 controls the instruction cache data RAM 11, the instruction cache tag RAM 12, the selection circuits 19, 20, etc., in accordance with the request from the instruction fetch unit 18 and in accordance with the selection result of the selection circuit 20. The instruction cache control unit 13 also stores, for example, the address of the head word of the repeat block in the program.

The instruction cache tag RAM 12 is a management information memory for storing operation history, etc., and stores tag information corresponding to an address (e.g., lines of the instruction cache data RAMs 11a, 11b) from the instruction cache control unit 13.

The tag comparator 17 compares tag information from the instruction cache tag RAM 12 with the address from the instruction cache control unit 13, and outputs the result of the comparison to the way indicator 16 and the selection circuit 20.

The selection circuit 19 is controlled by the instruction cache control unit 13, and selects the instruction code from the instruction cache data RAM 11 or the instruction code from the repeat buffer 14 and then outputs the selected instruction code to the instruction fetch unit 18.

The selection circuit 20 is controlled by the instruction cache control unit 13, and selects the output of the way indicator 16 or the output of the tag comparator 17 and then outputs the selected output to the instruction cache control unit 13.

Here, in executing the program of the microprocessor, the exclusion of the nested structure of the repeat block allows one storage set of a program counter to correspond to the repeat block. In the case described in the present embodiment, the nested structure of the repeat block is excluded for the simplification of explanation.

That is, assume that after the issuance of a repeat instruction in the program, the execution of the program in accordance with the instruction code supplied from the instruction cache data RAM 11 has progressed, and the counter value of the program being executed has reached the program counter value of the terminal word of the repeat block. Then, the instruction fetch unit 18 issues a fetch request (repeat request) based on repeat operation to the instruction cache control unit 13.

In response to the fetch request based on the repeat operation, the instruction cache control unit 13 initializes the entry pointer 15 (in the present example, sets the entry pointer 15 to, e.g., “0”). Then, whether the entry in the repeat buffer 14 indicated by the entry pointer 15 is effective is determined. When the entry is not effective, a request (address) is issued to the instruction cache data RAM 11. Subsequently, when an instruction code is output from the instruction cache data RAM 11, the selection circuit 19 is controlled so that the instruction code is output to the instruction fetch unit 18 and stored in the corresponding entry of the repeat buffer 14.

Thereafter, if the program is sequentially executed by the instruction code in the repeat block (without any jump due to a branch), a sequential request is issued from the instruction fetch unit 18. Then, the instruction cache control unit 13 sequentially checks the entries to the repeat buffer 14 (in order while incrementing the entry pointer 15 at each request). When the entry is not effective, the instruction cache control unit 13 repeats the operation of storing the instruction codes from the instruction cache data RAM 11 in the repeat buffer 14.

The instruction cache control unit 13 does not perform the operation of sequentially storing the instruction codes in the repeat buffer 14 in the following cases:

(1) The entry in the repeat buffer 14 pointed by the entry pointer 15 is already effective.

(2) The program has made a jump due to a branch, and a fetch request in response to the branch (branch request) has been received from the instruction fetch unit 18 (the entry pointer 15 is set to a value so that it does not point any entry in the repeat buffer 14).

(3) All the entries of the repeat buffer 14 have been checked (the instruction codes have reached the capacity of the repeat buffer 14, and the entry pointer 15 is set to a value so that it does not point any entry in the repeat buffer 14).

Then, when the fetch request based on the repeat operation has again received in the instruction cache control unit 13, the entry pointer 15 is initialized. Further, the head entry of the repeat buffer 14 is designated, and the sequential checking of the effectiveness of the entries is started.

When the instruction codes have already stored in the entries in the repeat buffer 14 as a result of the previous execution of the program in accordance with the instruction codes in the repeat block, the instruction cache control unit 13 does not access the instruction cache data RAM 11. In this case, the instruction code from the effective entry in the repeat buffer 14 pointed by the entry pointer 15 is output to the instruction fetch unit 18 via the selection circuit 19. Then, the entry pointer 15 is incremented, and the entry pointer 15 points the next entry, thus preparing for the next sequential request. The entry pointer 15 is not incremented in the following cases:

(1) The program has made a jump due to a branch, and a fetch request in response to the branch has been received from the instruction fetch unit 18 (the entry pointer 15 is set to a value so that it does not point any entry in the repeat buffer 14).

(2) All the entries of the repeat buffer 14 have been checked (the instruction codes have reached the capacity of the repeat buffer 14, and the entry pointer 15 is set to a value so that it does not point any entry in the repeat buffer 14).

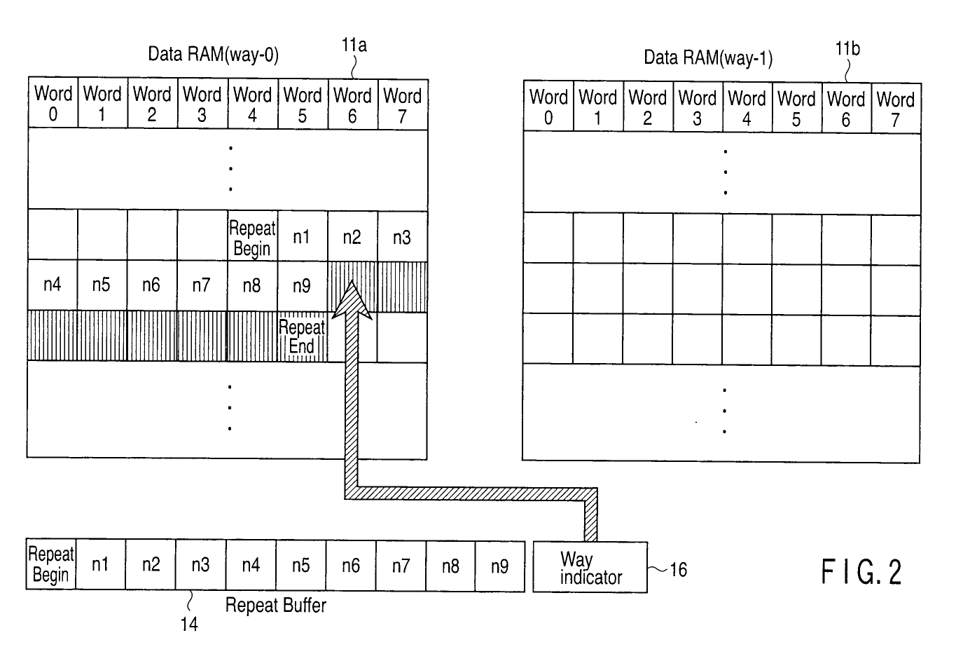

FIG. 2 is shown to explain an example of the operations of the repeat buffer 14 and the way indicator 16. One word (word n; n=1, 2, . . . , n1, n2, . . . ) indicates an instruction code per fetch requested from the instruction fetch unit 18. One example of operation is described in the present embodiment where the instruction cache data RAM 11 has a 2-way, 8-word/line configuration composed of the set associative instruction cache data RAMs 11a, 11b.

In FIG. 2, for example, the head word (repeat begin) of the repeat block is stored in the middle of a certain line of the instruction cache data RAM 11a. On the other hand, word data for the buffer size (the repeat begin to n9 as an instruction code group) is stored in the entries of the repeat buffer 14 starting from the head word of the repeat block.

In the case of the present embodiment, for example, as shown in FIG. 2, the word data (the repeat begin to repeat end) of the repeat block do not have to be aligned on one line of the instruction cache data RAM 11a. Moreover, the size (capacity) of the repeat buffer 14 does not depend on the line size of the instruction cache data RAM 11a and can be freely set. It is well conceived that the word data for the buffer size is stored in the repeat buffer 14 starting from the head word of the repeat block independently of the line size of the instruction cache data RAM 11a, such that the terminal word (instruction code n9) of the repeat buffer 14 is located in the middle of the line of the instruction cache data RAM 11a.

Here, in the case of using 2-way or more set associative instruction cache data RAMs, it is necessary to access the instruction cache data RAMs of all the ways and obtain the succeeding instruction code if it is not possible to determine which of the instruction cache data RAMs of a plurality of ways the instruction code following the terminal word (instruction code n9) of the repeat buffer 14 is stored in. That is, extra power consumption is caused if the instruction cache data RAMs of all the ways are accessed every time the instruction codes (the repeat begin to n9) in the repeat buffer 14 are used up.

Therefore, in the present embodiment, when the instruction code is stored in the repeat buffer 14, way information for the instruction cache data RAM storing the instruction code following the terminal word (instruction code n9) is managed by the way indicator 16. Thus, after the terminal word (instruction code n9) of the repeat buffer 14 has been fetched, the succeeding instruction code can be easily fetched by only accessing the instruction cache data RAM 11a pointed by the way indicator 16. That is, the instruction cache data RAM storing the succeeding instruction code is only activated, such that unnecessary power consumption can be inhibited.

In the case where the nested structure of the repeat block is excluded as in the present embodiment, if a repeat request (a request to fetch the instruction code of the head word of the repeat block) is made during the execution of the program, the address of the instruction code corresponding to the fetch request (the head word repeat begin) is uniquely determined. Therefore, the address of the head word of the repeat block in the program is stored in the instruction cache control unit 13, such that even when an instruction fetch targeted at the head word of the repeat block is produced by the repeat request, it is possible to output the instruction code of the head word of the repeat block to the instruction fetch unit 18 by only identifying the kind of instruction fetch (the sequential request, the repeat request, and a branch request excluding repeats) without comparing, by an address comparator, the address of the instruction code to be fetched.

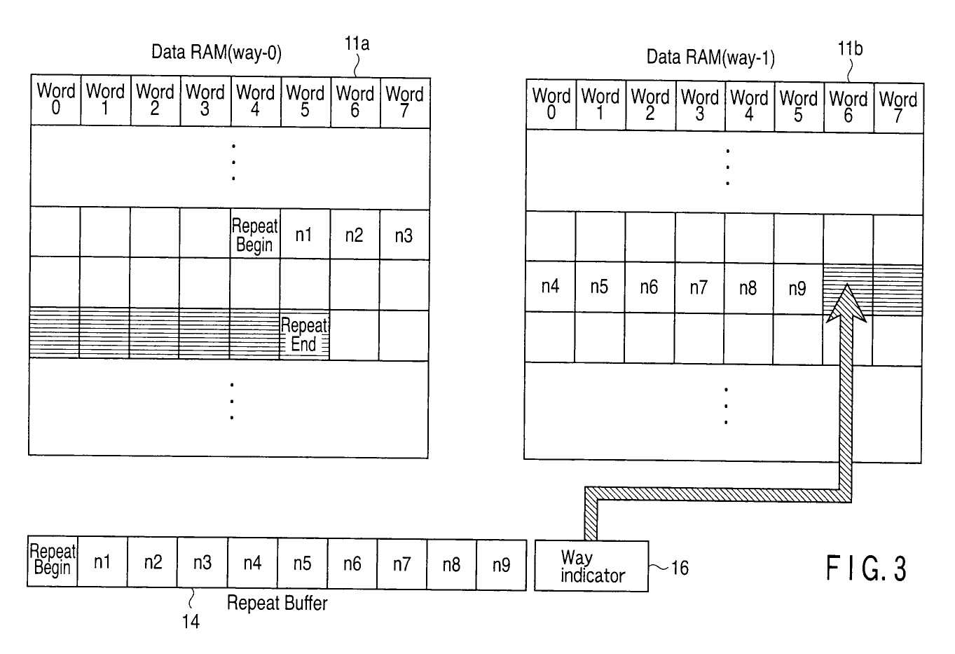

Furthermore, according to the configuration of the present embodiment, the size of the repeat buffer 14 can be freely set without depending on the physical structure of the instruction cache data RAM 11 for fetching an instruction code. In particular, the repeat buffer 14 can fully function even when the instruction code group (the repeat begin to n9) to be stored in the repeat buffer 14 crosses the boundary between the instruction cache data RAMs 11a, 11b and is present in a plurality of ways-0, 1, for example, as shown in FIG. 3.

Next, the operation of the instruction cache system 10 having the above-mentioned configuration will be described. For example, when a repeat block in the program is executed, the storage of an instruction code which is the head word of the repeat block in the repeat buffer 14 is started from the timing of the return of the program execution to the head word of the repeat block as a result of the first repetition of the repeat block. Then, the storage of the instruction code in the repeat buffer 14 is ended when the instruction codes have reached the full capacity of the repeat buffer 14 or when the storage has been finished up to the instruction code (repeat end) of the terminal word of the repeat block or when a “branch” is made in the repeat block. Then, the instruction code is supplied from the repeat buffer 14 to the instruction fetch unit 18 every time the program execution is returned to the head word of the repeat block due to the repetition of the repeat block. This makes it possible to reduce the accesses to the instruction cache data RAM 11 repeating the repeat block and thus reduce power consumption associated with the access to the instruction cache data RAM 11.

Furthermore, after the instruction codes of the repeat buffer 14 have been used up, access is ensured only to the instruction cache data RAM storing the instruction code succeeding the instruction code in the repeat buffer 14 in accordance with the way information from the way indicator 16, such that unnecessary power consumption can be inhibited.

As described above, in executing the repeat block in the program, the instruction code is output from the repeat buffer by hitting the entry in the effective repeat buffer. Moreover, when the instruction code in the set associative instruction cache data RAM is stored in the repeat buffer, a flag indicating the way to be accessed next is managed by the way indicator so that the instruction code succeeding the terminal word in the repeat buffer may be easily fetched. This makes it possible to reduce the number of accesses to the instruction cache memory in executing the repeat block in the program and reduce power consumption associated with the access to the instruction cache memory. In addition, it is also possible to hold down extra power consumption due to the accesses to the instruction cache data RAMs of all the ways after the repeat buffer has been accessed.

Moreover, this can be carried out with no need for a control circuit for causing the buffer to start the storage of the instruction code and an address comparator for the address comparison between the fetched instruction code and the instruction code stored in the buffer.

### Second Embodiment

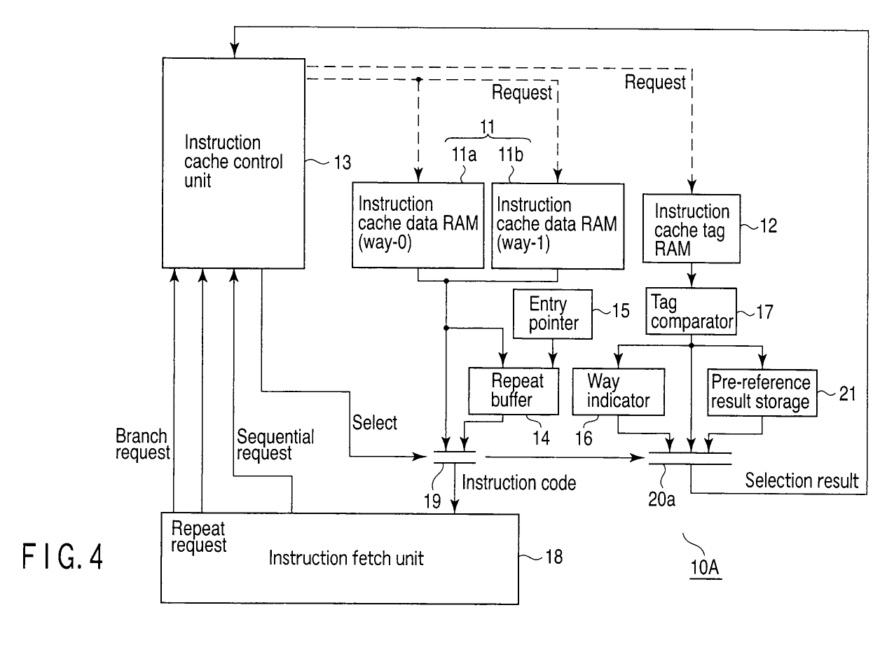

FIG. 4 shows an example of the configuration of an arithmetic processing apparatus (microprocessor) according to a second embodiment of the present invention. In the case described in the present embodiment where an instruction cache system comprises a repeat buffer, an instruction code from an instruction cache memory is stored in the repeat buffer, and an instruction cache tag RAM is precedently read (pre-referenced) when the instruction code is read from the instruction cache memory, such that power consumption associated with the access to the instruction cache memory can be reduced. It is to be noted that the same signs are assigned to the same parts as those in the instruction cache system shown in FIG. 1 and such parts are not described in detail. Particularly, the basic operation (e.g., the repeat operation) of an instruction cache system 10A is similar to that of the instruction cache system 10 described above, and therefore, different parts alone are described.

That is, the instruction cache system 10A having a tag memory pre-reference function as well comprises an instruction cache memory (e.g., instruction cache data RAMs [way-0] 11a, [way-1] 11b) 11, an instruction cache tag RAM 12, an instruction cache control unit 13, a repeat buffer 14, an entry pointer 15, a way indicator 16, a tag comparator 17, an in-processor instruction fetch unit 18, selection circuits 19, 20a, and a pre-reference result storage 21.

Here, the “tag memory pre-reference function” is a function which can be used when instruction codes to be successively fetched are present across the boundary between the lines of the instruction cache data RAMs in the case of using 2-way or more set associative instruction cache data RAMs.

The operation and effects of the tag memory pre-reference function are described below. For example, assume a case where sequential requests of successive addresses are issued from the instruction fetch unit 18. In this case, it is expected that a fetch target word (instruction codes per fetch requested from the instruction fetch unit 18) requested by the first sequential request is, for example, the final word of the end line of the particular instruction cache data RAM 11a, and a fetch target word requested by the next sequential request is present in the other instruction cache data RAM 11b across the boundary between the lines. Then, the address of the fetch target word which would be requested by the next sequential request is previously created in the instruction cache control unit 13. For example, at the time of a fetch access before the crossing of the boundary between the lines of the instruction cache data RAMs 11a, 11b, tag information corresponding to the next line is read in advance from the instruction cache tag RAM 12, so that an address is generated which is expected to be accessed by a sequential fetch request crossing the next line boundary. Then, tag information in the instruction cache tag RAM 12 is first read in accordance with this address, and the read tag information is compared with the above address, and the result of the comparison is then stored in the pre-reference result storage 21. The result of the comparison in the pre-reference result storage 21 thus obtained is referred to by the instruction cache control unit 13 via the selection circuit 20a, such that it is possible to previously know the instruction cache data RAM containing the fetch target word which would be actually requested by the next sequential request.

Owing to this function, the instruction cache data RAM storing the target instruction code is only activated without activating all the instruction cache data RAMs 11a, 11b, so that power consumption in the instruction cache data RAM 11 can be significantly reduced. In addition, when the comparison result in the tag comparator 17 is obvious, it is not necessary to read the instruction cache tag RAM 12 with the timing of newly crossing the boundary between the lines of the instruction cache data RAMs 11a, 11b.

On the other hand, the operation of this “tag memory pre-reference function” is stopped when the repeat buffer 14 is effective during the above-mentioned repeat operation and it is apparent that the instruction codes present across the boundary between the lines of the instruction cache data RAMs 11a, 11b are already in the repeat buffer 14 (e.g., see FIG. 3). This makes it possible to prevent unnecessary reading of the instruction cache tag RAM 12 when the repeat buffer 14 is functioning.

In addition, while the timing of generating the tag pre-reference operation is set to the point where the fetch target word is the final word of the end line in the case described above as an example, advancing the timing of pre-reference is substantially possible in achieving this function.

### Third Embodiment

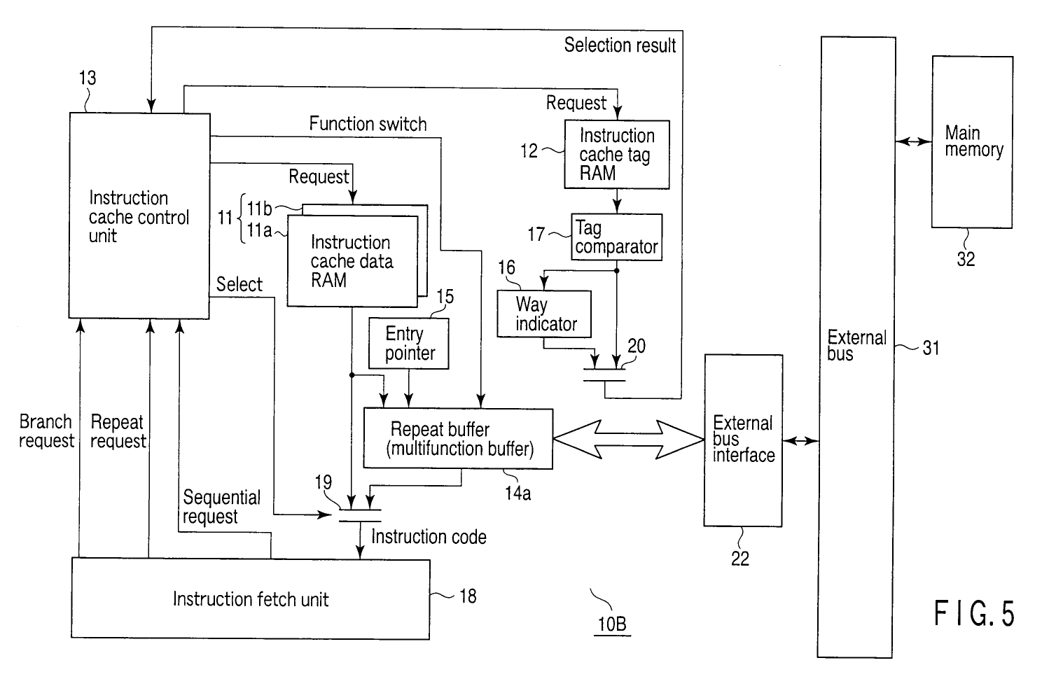

FIG. 5 shows an example of the configuration of an arithmetic processing apparatus (microprocessor) according to a third embodiment of the present invention. In the case described in the present embodiment where an instruction cache system comprises a repeat buffer, the repeat buffer is a multifunction buffer which not only stores instruction code groups in a repeat block but also has a function as a pre-fetch buffer of an instruction cache memory. It is to be noted that the same signs are assigned to the same parts as those in the instruction cache system shown in FIG. 1 and such parts are not described in detail. Particularly, the basic operation (e.g., the repeat operation) of an instruction cache system 10B is similar to that of the instruction cache system 10 described above, and therefore, different parts alone are described.

That is, this instruction cache system 10B comprises an instruction cache memory (e.g., instruction cache data RAMs 11a, 11b) 11, an instruction cache tag RAM 12, an instruction cache control unit 13, a repeat buffer (multifunction buffer) 14a, an entry pointer 15, a way indicator 16, a tag comparator 17, an in-processor instruction fetch unit 18, selection circuits 19, 20, and an external bus interface 22.

The external bus interface 22 is connected to a main memory (main storage) 32 via an external bus 31.

In the case of the present embodiment, the repeat buffer 14a also functions as a prefetch buffer of the instruction cache data RAMs 11a, 11b in accordance with a direction from the instruction cache control unit 13 via a function switch control line. That is, when there is no repeat block in the program being executed, the repeat buffer 14a is not used as a repeat buffer for storing the instruction code group in the repeat blocks. For example, the instruction code which would be requested by the instruction fetch unit 18 and which corresponds to the instruction cache data RAMs 11a, 11b and which comes from the main memory 32 linked to the external bus 31 is retained by the prefetch buffer function previously allocated to the repeat buffer 14a. This makes it possible to significantly reduce the latency of the external bus when a request is actually made from the instruction fetch unit 18 to the instruction cache data RAMs 11a, 11b.

On the other hand, assume that in the repeat operation described above, a repeat block in a program is executed while the repeat buffer 14a is functioning as the prefetch buffer and a repeat request is then made from the instruction fetch unit 18 to the instruction cache control unit 13. In this case, if the repeat buffer 14a is being used (in the present example, this means an event wherein the instruction code which this buffer retains as the prefetch buffer is being read or wherein the instruction cache data RAMs 11a, 11b are being refilled), the instruction code which this buffer retains as the prefetch buffer is not destroyed. However, when the instruction code which this buffer retains as the prefetch buffer is not used, this instruction code is destroyed. Then, in accordance with the direction from the instruction cache control unit 13 via the function switch control line, the repeat buffer 14a functions as the repeat buffer for storing the instruction code group in the repeat block.

In addition, the “tag memory pre-reference function (see the second embodiment)” can be added in the present embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An arithmetic processing apparatus comprising:
a cache block which stores at least some of a plurality of instruction codes in a processing program stored in a main memory;
a central processing unit which fetch-accesses the cache block and sequentially loads and executes the at least some of a plurality of instruction codes;
a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block; and
an instruction cache control unit which performs control so that the instruction code group stored in the repeat buffer is selected and supplied to the central processing unit when the repeat block is repeatedly executed.

2. The arithmetic processing apparatus according to claim 1, wherein the instruction cache control unit selects either the output of the instruction code group from the repeat buffer or the output of the at least some of a plurality of instruction codes from the cache block, in accordance with the kind of instruction fetch with no need for an address comparison of the instruction code group in the repeat block stored in the repeat buffer during the fetch access by the central processing unit.

3. The arithmetic processing apparatus according to claim 2, wherein the kind of instruction fetch corresponds to a sequential fetch request having successive addresses during the fetch access, a fetch request based on a repeat operation which repeatedly executes the repeat block, or a fetch request based on branching other than the fetch request based on the repeat operation, and
the instruction cache control unit selects the output of the instruction code group from the repeat buffer when the kind of instruction fetch corresponds to the fetch request based on the repeat operation.

4. The arithmetic processing apparatus according to claim 1, wherein the cache block is configured to have a plurality of data random access memories (RAMs),
the arithmetic processing apparatus further comprising a way indicator which indicates the data RAM storing the instruction code following the terminal instruction code of the instruction code group stored in the repeat buffer.

5. The arithmetic processing apparatus according to claim 4, wherein the plurality of data RAMs are set associative instruction cache data RAMs, respectively.

6. The arithmetic processing apparatus according to claim 1, further comprising:
a tag RAM which stores tag information corresponding to a line of the cache block; and
a storage which previously reads tag information corresponding to the next line from the tag RAM at the time of a fetch access before the crossing of the boundary of the line of the cache block in order to generate an address expected to be accessed by a sequential fetch request crossing the boundary of the next line, thereby retaining the result of a comparison between the address and the tag information,
wherein when actually accessing the cache block in response to the sequential fetch request crossing the line boundary from the central processing unit, the instruction cache control unit controls the access to the cache block on the basis of the comparison result retained in the storage.

7. The arithmetic processing apparatus according to claim 1, wherein the repeat buffer is configured by a multifunction buffer also functioning as a pre-fetch buffer of the cache block which stores the plurality of instruction codes stored in the main memory, and
the use of the multifunction buffer is switched and controlled in accordance with a fetch request from the central processing unit so that the multifunction buffer functions as the pre-fetch buffer when there is no repeat block to be repeatedly executed in the processing program.

8. The arithmetic processing apparatus according to claim 1, further comprising: an entry pointer which stores an entry targeted to process in the repeat buffer,
wherein the value of the entry pointer is incremented at each of the sequential fetch requests.

9. An arithmetic processing apparatus comprising:
a cache block which stores at least some of a plurality of instruction codes in a processing program stored in a main memory;
a central processing unit which fetch-accesses the cache block and sequentially loads and executes the at least some of a plurality of instruction codes;
a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block;
an instruction cache control unit which performs control so that the instruction code group stored in the repeat buffer is selected and supplied to the central processing unit when the repeat block is repeatedly executed;
a tag RAM which stores tag information corresponding to a line of the cache block; and
a storage which previously reads tag information corresponding to the next line from the tag RAM at the time of a fetch access before the crossing of the boundary of the line of the cache block in order to generate an address expected to be accessed by a sequential fetch request crossing the boundary of the next line, thereby retaining the result of a comparison between the address and the tag information,
wherein when actually accessing the cache block in response to the sequential fetch request crossing the line boundary from the central processing unit, the instruction cache control unit controls the access to the cache block on the basis of the comparison result retained in the storage.

10. The arithmetic processing apparatus according to claim 9, wherein the instruction cache control unit selects either the output of the instruction code group from the repeat buffer or the output of the at least some of a plurality of instruction codes from the cache block, in accordance with the kind of instruction fetch with no need for an address comparison of the instruction code group in the repeat block stored in the repeat buffer during the fetch access by the central processing unit.

11. The arithmetic processing apparatus according to claim 10, wherein the kind of instruction fetch corresponds to a sequential fetch request having successive addresses during the fetch access, a fetch request based on a repeat operation which repeatedly executes the repeat block, or a fetch request based on branching other than the fetch request based on the repeat operation, and
the instruction cache control unit selects the output of the instruction code group from the repeat buffer when the kind of instruction fetch corresponds to the fetch request based on the repeat operation.

12. The arithmetic processing apparatus according to claim 9, wherein the cache block is configured to have a plurality of data random access memories (RAMs),
the arithmetic processing apparatus further comprising a way indicator which indicates the data RAM storing the instruction code following the terminal instruction code of the instruction code group stored in the repeat buffer.

13. The arithmetic processing apparatus according to claim 12, wherein the plurality of data RAMs are set associative instruction cache data RAMs, respectively.

14. The arithmetic processing apparatus according to claim 9, further comprising: an entry pointer which stores an entry targeted to process in the repeat buffer,
wherein the value of the entry pointer is incremented at each of the sequential fetch requests.

15. An arithmetic processing apparatus comprising:
a cache block which stores at least some of a plurality of instruction codes in a processing program stored in a main memory;
a central processing unit which fetch-accesses the cache block and sequentially loads and executes the at least some of a plurality of instruction codes;
a repeat buffer which stores an instruction code group corresponding to a buffer size regardless of the line configuration of the cache block, the instruction code group ranging from a head instruction code to a terminal instruction code among the head instruction code to an end instruction code of a repeat block repeatedly executed in the processing program, in the at least some of a plurality of instruction codes stored in the cache block; and
an instruction cache control unit which performs control so that the instruction code group stored in the repeat buffer is selected and supplied to the central processing unit when the repeat block is repeatedly executed,
wherein the repeat buffer is configured by a multifunction buffer also functioning as a pre-fetch buffer of the cache block which stores the plurality of instruction codes stored in the main memory, and
the use of the multifunction buffer is switched and controlled in accordance with a fetch request from the central processing unit so that the multifunction buffer functions as the pre-fetch buffer when there is no repeat block to be repeatedly executed in the processing program.

16. The arithmetic processing apparatus according to claim 15, wherein the instruction cache control unit selects either the output of the instruction code group from the repeat buffer or the output of the at least some of a plurality of instruction codes from the cache block, in accordance with the kind of instruction fetch with no need for an address comparison of the instruction code group in the repeat block stored in the repeat buffer during the fetch access by the central processing unit.

17. The arithmetic processing apparatus according to claim 16, wherein the kind of instruction fetch corresponds to a sequential fetch request having successive addresses during the fetch access, a fetch request based on a repeat operation which repeatedly executes the repeat block, or a fetch request based on branching other than the fetch request based on the repeat operation, and
the instruction cache control unit selects the output of the instruction code group from the repeat buffer when the kind of instruction fetch corresponds to the fetch request based on the repeat operation.

18. The arithmetic processing apparatus according to claim 15, wherein the cache block is configured to have a plurality of data random access memories (RAMs), the plurality of data RAMs being set associative instruction cache data RAMs, respectively,
the arithmetic processing apparatus further comprising a way indicator which indicates the data RAM storing the instruction code following the terminal instruction code of the instruction code group stored in the repeat buffer.

19. The arithmetic processing apparatus according to claim 15, further comprising:
a tag RAM which stores tag information corresponding to a line of the cache block; and
a storage which previously reads tag information corresponding to the next line from the tag RAM at the time of a fetch access before the crossing of the boundary of the line of the cache block in order to generate an address expected to be accessed by a sequential fetch request crossing the boundary of the next line, thereby retaining the result of a comparison between the address and the tag information,
wherein when actually accessing the cache block in response to the sequential fetch request crossing the line boundary from the central processing unit, the instruction cache control unit controls the access to the cache block on the basis of the comparison result retained in the storage.

20. The arithmetic processing apparatus according to claim 15, further comprising: an entry pointer which stores an entry targeted to process in the repeat buffer,
wherein the value of the entry pointer is incremented at each of the sequential fetch requests.
